(19) United States
(12) Patent Application Publication
(10) Pub. No.: US 2023/0284665 A1
(43) Pub. Date: Sep. 14, 2023

(54) PROCESS FOR PRODUCING AT LEAST ONE INTERMEDIATE FOOD PRODUCT CAPABLE OF FORMING A MOUSSE AND/OR HAVING EMULSIFYING AND/OR GELLING PROPERTIES - ASSOCIATED PRODUCTS

(71) Applicant: GRAINE DE CHOC, Beuvraignes (FR)

(72) Inventor: Béatrice MAIRE, Beuvraignes (FR)

(21) Appl. No.: 18/019,544

(22) PCT Filed: Aug. 2, 2021
(86) PCT No.: PCT/FR2021/051436

§ 371 Date: Feb. 3, 2023

(30) Foreign Application Priority Data
Aug. 4, 2020 (FR) FR2008264

(51) Int. Cl. A23L 29/10; A23L 29/238

(52) U.S. Cl. CPC A23L 29/10; A23L 29/238

(57) ABSTRACT

The present invention relates to a culinary method for preparing an intermediate food product or IFP having gelling and emulsifying properties and serving as a texturizing agent for making a final food product in the form of a gelatin, mousse or emulsion. The method includes a step of supplying field beans.

### TECHNICAL FIELD

The present invention relates to the field of the food industry.

The object of the present invention relates more particularly to a method for preparing a field bean-based intermediate food product (“IFP”) (or ingredient), such IFP being capable of serving as a texturizing agent having gelling and emulsifying properties.

The present invention will find many advantageous applications in the food industry by providing users and various actors in the food industry with an IFP of vegetable origin (and not of animal origin like the vast majority of IFPs) for preparing a final food product in the form of a gelatin, mousse or emulsion.

### PRIOR ART

The IFPS refer to mixtures of products from the food industry which have undergone a treatment and/or a processing.

They are mainly used to:
make production more profitable,
texturize or enrich a food, and/or
   ensure bacteriological safety of the finished product.

The manufacturers of IFPS thus play a decisive role in the food industry since the preparation of these IFPS constitutes true functional ingredient vectors.

However, the Applicant indicates that the preparation of these IFPS raises numerous issues.

The Applicant thus observes that these IFPS are often ultra-processed foods that can generate health problems in the medium or long term.

These multiple processings are moreover energy-consuming and increase the manufacturing cost by making the manufacturing process more complex.

The Applicant further observes that in France these IFPS are often derived from imported raw materials, which raises environmental and ecological issues.

Finally, the Applicant observes that these IFPS often consist of a multitude of ingredients; this goes against the healthy formulations of the “clean labels” type which are now expected, even demanded, by consumers.

The company TAMAGO FOOD which has developed the product YUMGO® is known.

YUMGO® is an allergen-free vegetable egg white substitute with an equivalent nutritional value. This product is essentially comprised of vegetable proteins and provides a relatively short list of ingredients in order to remain as natural as possible. The use of YUMGO® therefore replaces egg white and allows a plurality of culinary recipes in the field of pastry making to be made.

However, the Applicant indicates that YUMGO® still requires several ingredients (water, potato protein, acacia fiber, flax fiber, xanthan gum, salt) and involves several processings; this is not fully satisfactory.

The British company ALTERNATIVE FOODS LONDON LIMITED which has developed the product OGGS® AQUAFABA, is also known.

This product is also a vegetable alternative to eggs and allows a plurality of culinary recipes in the field of pastry to be made.

OGGS® AQUAFABA product is mainly obtained from chickpeas.

The Applicant indicates, however, that OGGS® AQUAFABA, like YUMGO®, does not allow an IFP serving as a texturizing agent with gelling and/or emulsifying properties to be obtained. However, they can allow a mousse to be obtained, which can be cooked (meringue or macaroon). The products obtained from chickpeas all have a certain bitterness and/or a particular taste which sometimes disappears during cooking. They can only be used in preparations containing a sweetener, which allows this bitterness to be masked. Used raw, the taste of chickpeas persists, which limits their use to cooked preparations.

Moreover, the cooking water of chickpeas contains lectins and saponins which are bitter. Such components can be toxic or limit the absorption of certain nutrients; they should therefore be limited in human feed.

Document FR 2 942 586 A1 describes a product containing pea proteins and a starch hydrolysate. This product is in powder form and can be used as a hot gelling agent due to the presence of the starch hydrolysate.

Document WO2018/183729 A1 describes a protein concentrate obtained by the HMT method, which does not destroy the grain structure of the starch. The result of the HMT treatment is visible on the loss of birefringence of the starch observable under bipolarized light. The powdered product obtained from field beans is used as an emulsifier in an ice cream.

Document WO 2015/158959 A1 describes a method for manufacturing a fermented powdered food based on field beans. This food is intended to replace flour.

Document WO 2016/096663 A1 describes a method for manufacturing a food in gel form from vegetable starch. Field bean is not mentioned.

All of the products in prior art that can be used to make a mousse and/or have an emulsifying and/or gelling power are in powder form. Since powders contain little water, they avoid any bacterial proliferation and are therefore stable over time. Nevertheless, they are sometimes difficult to mix.

Document WO 2014/174149 A1 describes a method for manufacturing a liquid product based on field beans, intended to replace milk. Field beans are rehydrated and dehulled; they are then mixed with water, ground and centrifuged. The liquid obtained is boiled for 10 minutes so as to denature the proteins. An oil is then added to the aqueous solution obtained from the field beans. The addition of an oil allows the formation of an emulsion. However, it increases the caloric intake of the food, which is not desirable.

### Technical Problems

The present invention aims to remedy all or part of the drawbacks associated with the products and methods of prior art.

More particularly, the present invention aims to remedy the various drawbacks mentioned above by providing a 100% vegetable solution which is easy to implement industrially (few processings), which requires a minimum of ingredients and which allows the preparation of an IFP serving as a texturizing agent having gelling and/or emulsifying properties for making a final food product in the form of a gelatin, a mousse or an emulsion.

A further purpose of the present invention is to provide a product obtained from a single food, which can be easily mixed and which allows the formation of a mousse and/or emulsion and/or which has gelling properties.

A further purpose of the present invention is to provide a wet texturizing agent, being in liquid form or gel form.

A further purpose of the present invention is to provide an intermediate food product which allows the reduction of the amount of sugar and/or oil in culinary preparations such as meringues or mayonnaise, for example.

### BRIEF SUMMARY OF THE INVENTION

The present invention relates to a method for preparing a food ingredient which makes it possible to form a mousse and/or has emulsifying and/or gelling properties, according to which field beans are dehulled, rehydrated and then, after draining, mixed with water and ground, and the mixture obtained is then heated to a temperature of between 90° C. and 110° C. so as to obtain a liquid and/or gel.

The cooking can be carried out at atmospheric pressure or under pressure.

Field beans are commonly used raw for animal feed. They contain less protein than soybeans or chickpeas and it is therefore surprising that they can be used to produce an IFP to obtain a mousse.

Soaking and dehulling remove most of the saponins and lectins contained in the field bean.

Advantageously, field bean varieties that do not contain vicine and convicine are used.

The use of field beans has never been contemplated before and allows the desired properties to be obtained.

Field beans are part of the legume family and furthermore provide advantageous nutritional properties due to their protein content, especially.

In addition, it will be noted that field beans are widely cultivated in France, which avoids the import of raw materials from foreign countries, thus promoting short circuits. Preferably, the soaking is carried out for a soaking time of between 12 hours and 20 hours, preferably substantially equal to 16 hours.

Preferably, the soaking is carried out in two and a half volumes of water for one volume of field beans. It is therefore understood here that 2.5 volumes of water are provided for 1 volume of field beans. If soaking is implemented under these conditions, the desired moisture content for the field beans can be achieved quickly and efficiently.

Preferably, the moisture content achieved is of between 92 and 96%, preferably substantially equal to 94% moisture.

Advantageously, the method according to the present invention comprises, after soaking, a step of draining the field beans.

In one advantageous embodiment, the aqueous mixture comprises 28.5% field beans and 71.5% water. These proportions allow an optimal process to be obtained.

It is understood that equivalent proportions with a percentage of field beans of between 25 and 30% and a percentage of water of between 70 and 75% allow in the same way very satisfactory results to be obtained.

Grinding is implemented so as to obtain particles with a size substantially equal to or greater than 1 mm and substantially equal to or less than 3 mm. Larger particles do not allow a good extraction of proteins and starch; finer particles tend to clog during cooking, which also prevents the extraction of proteins, especially.

This heating or cooking step makes it possible, on the one hand, to increase the foaming power of the field bean proteins to be increased either by denaturing the latter or by promoting the extraction of albumin (the Applicant is nevertheless not bound to these explanations) and on the other hand to make starch grains swell and to ensure the dispersion of amylose in water. It is also likely that an amylase contained in the field bean is released, which acts on starch, thus releasing each of its constituents, namely amylose and amylopectin.

Preferably, the heating time (cooking) is between 6 and 10 minutes, preferably substantially equal to 8 minutes.

Advantageously, said liquid and/or gel is separated from the cooked field beans or the cooked field bean grind and said liquid and/or gel is recovered, which forms the first IFP of the invention.

Such filtering can be carried out for example via a very fine sieve.

Preferably, it is desirable after filtering that the fibers and/or particles are not present in the viscous liquid.

Advantageously, the method according to the present invention comprises a heat treatment to sterilize said viscous mixture.

This heat treatment is advantageously implemented at a temperature equal to or higher than 100° C. and equal to or lower than 150° C., preferably 120° C. for a time equal to or higher than 30 mins and equal to or higher than 60 mins, preferably equal to 50 mins, at atmospheric pressure. This heat treatment not only destroys the microorganisms but also denatures the proteins, which increases the emulsifying power and the foaming power (expansion coefficient) of the product obtained. This same heat treatment can be implemented on the 2nd and 3rd IFP of the invention when it is not implemented on the first IFP of the invention.

Advantageously, the heat treatment is implemented for 50 mins at 120° C. and at ambient pressure.

According to a particular implementation, the product obtained is separated into a solid phase and a liquid phase, either by demixing or by adding an acid. An acid is added before or after the heat sterilization step so as to obtain a liquid phase and a phase in the form of a gel or jelly (solid phase). The acid is not limited according to the invention, it can be a strong or weak, organic or mineral acid. It can be, for example, hydrochloric acid or citric acid. Demixing is obtained by leaving the product at rest.

The object of the present invention relates, according to a second aspect, to a field bean-based intermediate food product, or IFP, obtained following the implementation of a method as described above.

According to a first embodiment of the intermediate food product according to the invention, this IFP is capable of forming a mousse and/or has emulsifying and/or gelling properties; it is in the form of a liquid and/or a gel, and it comprises or consists of water, vegetable proteins, field bean starch and/or amylose and/or amylopectin and it forms a solid precipitate when adding an acid.

Advantageously, it has a pH equal to or greater than 6.5 and less than or equal to 7.2 and especially equal to 6.80.

The product obtained (first IFP) is in the form of a gel or a gel and liquid mixture. It contains water and preferably at least 2.5% by mass of protein (in particular 2.9% by mass of protein) and at least 4% by mass of field bean starch and in particular 4.7% by mass of field bean starch.

This first product advantageously contains water, 2.5% to 3.5% by mass, in particular 2.9% by mass of protein and 4.2% to 5.2%, in particular 4.7% by mass of field bean starch. The limits of the ranges are included.

The first product of the invention has a complex composition which is difficult to determine. It contains amylose and amylopectin which are derived from the retrogradation (gelatinization) of field bean starch. It also contains water-soluble proteins, which are degraded to make a mousse. Some of these proteins are probably vegetable albumins. Other proteins make it possible, above all in their degraded form, to provide an emulsifying power to the product. This first IFP, as well as the other two, optionally further contains saponins. However, the applicant is not bound by these explanations.

According to a second embodiment of the product of the invention, it is in the form of a gel or jelly and has gelling and/or emulsifying properties. It contains or consists of amylose, water and optionally vegetable proteins.

The pH of this product is advantageously lower than 7 and especially lower than 6.5. The vegetable proteins it contains may be or comprise albumins. This product liquefies at a temperature greater than or equal to 60° C.; it can thus be easily hot-mixed. It becomes a jelly again at room temperature and thus allows preparations to be gelled in order to obtain flans, jelly or other. When it is hot-molded, it forms a solid upon cooling which retains its shape for at least three days at room temperature. The aforementioned sterilization heat treatment increases the foaming and emulsifying power of this 2nd IFP.

This second product contains or consists of water, amylose and vegetable proteins. It can contain saponins and/or amylopectin but in lesser amount than amylose. This 2nd IFP forms a stable emulsion with oil for at least 24 hours at room temperature. It forms a mousse (expanded preparation) stable at 20° C. for at least 24 hours.

This 2nd IFP has an expansion coefficient greater than or equal to 100 and less than or equal to 180 and especially equal to 143 or 150, measured under the operating conditions described in the “Examples” section of this patent application.

The mousse obtained with a household whisk has a specific gravity greater than 1.02 and less than 1.1 and especially equal to 1.05.

It does not react with a strong or weak acid.

This 2nd IFP makes it possible to obtain an emulsion (mayonnaise) containing from 30% to 40% by mass of oil (limits included). The oil used is not limited and the above-mentioned examples can be used to obtain a mayonnaise. The emulsion is obtained after 1 minute with a household whisk and remains firm for at least 2 days, and even three or four days.

This 2nd IFP makes it possible to obtain a whipped cream (expanded preparation) that is stable for at least 24 hours. It can also be cooked and replace the egg yolk in cake batters, especially brioche. It allows mayonnaise-type sauces to be made by reducing the amount of fat compared to the use of egg yolk or other egg substitutes. It probably contains pectin and amylose; it creates a quick and long-lasting sensation of satiety (appetite suppressant food). It allows vegetable cream desserts to be quickly made without going through a fermentation step. Its gelling properties are reversible: once the product is gelled, it liquefies when hot and becomes solid again at room temperature.

It serves as a gelling agent to obtain flans and creams. It replaces liquid cream in the manufacture of espumas.

The operating conditions for obtaining the mousse are those indicated in the “Examples” section of this application (room temperature of 20° C.)

According to a third embodiment of the product of the invention, it is liquid and capable of forming a mousse and/or having emulsifying properties. It contains or consists of water, vegetable proteins (including albumins) and amylopectin. It can be used for replacing egg white to obtain mousses, meringues or cake batter. It can be used as an egg yolk substitute to obtain an emulsion such as mayonnaise. This 3rd IFP has an expansion coefficient greater than or equal to 400 and less than or equal to 500 and especially equal to 428. It makes it possible to obtain a stable mousse with a household whisk for 8 hours at 20° C. It also forms an emulsion (mayonnaise) stable for 8 hours at 20° C. It makes it possible to obtain firm meringues that retain their shape after cooking with a preparation containing 30% by mass of sugar and 70% by mass of this 3rd IFP.

The mousse obtained with this 3rd IFP and in accordance with the operating conditions described in the “Examples” section, has a specific gravity greater than 0.1, preferably greater than 0.15 and less than 0.25 and especially equal to 0.18.

With an addition of acid to this 3rd IFP (1 g of strong acid for 30 g of product), a precipitate containing or consisting of proteins is obtained.

This 3rd product also forms a stable emulsion with oil for at least 18 hours at room temperature (20° C.), with the addition of acid. This emulsion retains its shape and is firmer than the emulsion obtained from aquafaba. The oil used is not limited according to the invention. It can be rapeseed oil, sunflower oil or grape seed oil. The oil represents 70% to 90% by mass of the mayonnaise and especially 80% by mass of the mayonnaise for the 3rd IFP.

In all cases, the mayonnaise is obtained with a household whisk and under the conditions described in the “Examples” section.

It has a neutral taste and does not require the addition of any sweetener other than sugar and/or flavors. Although the Applicant is not bound by the following explanations, it is likely that this third product is richer in amylopectin than the first and second products of the invention. This third IFP is probably formed by separating amylose and amylopectin. The amylose forms a gel or solid phase which rejects its water; it is mostly present in the second IFP. The water-soluble amylopectin separates from the amylopectin and passes into the aqueous phase, probably with the water-soluble proteins to form the 3rd IFP. Amylose is more abundant in field beans than in other legumes. It remains in the solid fraction which forms the second IFP of the invention and is organized in a mass due to physicochemical interactions between the molecules. Some proteins, whether degraded or not, remain in this mass and give the IFP an emulsifying power and allow it to be a mousse. The fact that the IFPS of the invention can form a mousse and/or an emulsion is surprising because they contain less protein than aquafaba for example. It is therefore a particular composition of vegetable proteins and starch contained in field beans that makes it possible to obtain the IFPS of the invention, these having properties that are superior in terms of mousse and emulsion stability to those of aquafaba.

It should be noted that there are already IFPS using other legumes such as, for example, chickpeas (OGGS® AQUAFABA) or potatoes (YUMGO®); however, in addition to the gelling and emulsifying properties and ease of preparation, the use of field beans makes it possible to avoid the bitterness generated by the other vegetable protein flours and powders. The field bean-based IFPs of the invention indeed a neutral taste and do not require flavors or excessive addition of sugars to mask the taste.

According to a third aspect, the object of the present invention relates to a use of an intermediate food product or IFP as described above for making a mousse.

Preferably, the mousse according to this use allows at least one meringue, macaroon and/or sponge cake to be made.

According to a fourth aspect, the object of the present invention relates to a use of an intermediate food product or IFP as described above for making a neutral gelling preparation.

Preferably, the neutral gelling preparation according to this use allows savory or sweet flan to be made.

According to a fifth aspect, the object of the present invention relates to a use of an intermediate food product or IFP as described above for making a sauce or condiment. Preferably, the sauce or condiment according to this use is of the mayonnaise, aioli, bearnaise or ganache type.

By means of the various technical characteristics above, the present invention makes it possible to obtain easily from field beans and water alone an IFP in the form of a viscous mixture having interesting gelling and emulsifying properties, such an IFP being able to be used as a texturizing agent for making a final food product such as a gelatin, a mousse or even an emulsion.

The present invention also relates to food compositions for the manufacture of a food and which are in gel and/or liquid form; they contain at least one of the IFPS of the invention. These compositions also contain at least one ingredient selected from sweeteners, especially sucrose, a cereal flour, cocoa and an oil selected especially from sunflower oil, rapeseed oil and grape seed oil. These preparations are free of egg yolk and/or egg white. Advantageously, they consist of at least one of the IFPS, and preferably of an IFP and one or more of the aforementioned ingredients.

### Definitions

Moisture content: for the purposes of the present invention, moisture content is defined as the increase in mass of the field beans due to the absorption of water.

A gel, for the purposes of the present invention, is a viscous liquid which forms a volume that cannot be divided by flowing; in particular, a gel for the purposes of the invention does not pass through a kitchen sieve; the gel according to the invention cannot be molded, that is, take a shape in a mold and retain it, even for 1 minute, outside the mold.

The terms “gelling power” or “gelling properties” refer, for the purposes of the present invention, to the capacity of a product, when added to water or milk, to form a gel which can be molded and retain its shape for at least 10 minutes after demolding.

The term “starch” refers to a mixture of amylose and amylopectin.

The term “field bean starch” refers to a starch that contains 30% to 33% by mass of amylose.

The term “IFP” for intermediate food product refers to any composition serving a texturizing agent to obtain a final food product.

The term “aquafaba” refers to the cooking water of whole chickpeas.

The term “jelly” refers to a wet product which forms a mass at room temperature; this mass cannot be divided by flowing but can be crushed with a fork or beaten with a household mixer, especially.

The term “mousse” for the purposes of the present invention refers to a preparation containing air bubbles.

The term “emulsion” refers to a preparation of two immiscible liquids, one of which is in the form of a suspension of droplets in the other.

The term “espuma” refers to a preparation obtained by dispersion of carbon dioxide or nitrous oxide in a more or less viscous liquid.

The “expansion coefficient” is measured as follows: ((mass of the expanded product-mass of the product before expansion)/mass of the expanded product)×100; the expanded product is the product beaten by hand with a household whisk.

A denatured protein is, for the purposes of the invention, a protein whose conformation is different from the native protein or a protein fragment derived from a native protein.

### BRIEF DESCRIPTION OF THE FIGURES

Further characteristics and advantages of the present invention will become apparent from the description below with reference to the single appended FIG. 1, which illustrates an exemplary embodiment thereof in no way limiting and in which:

FIG. 1 represents a flow chart representing the various steps of the culinary method for preparing an intermediate food product IFP according to an example embodiment of the present invention;

FIG. 2a represents a mousse obtained with the first IFP and having been left to rest for 4 hours at room temperature, FIG. 2b represents a mousse which has just been prepared from aquafaba under the same conditions as the mousse made with the first IFP of the invention and FIG. 2c represents the mousse obtained with aquafaba and after 4 hours of rest at room temperature;

FIG. 3a represents meringues made with 30% by mass of added sugar and aquafaba and FIG. 3b represents meringues made with 30% by mass of sugar and the third IFP of the invention instead of aquafaba;

FIG. 4a represents a cocoa flan obtained with aquafaba and FIG. 4b represents a flan obtained with the second IFP of the invention;

FIG. 5 represents on the left the first IFP of the invention in which hydrochloric acid has been added and on the right aquafaba in which the same amount of hydrochloric acid has been added;

FIG. 6 represents the two separate phases that have been obtained by adding hydrochloric acid in the first IFP of the invention;

FIG. 7a represents a preparation obtained by whipping the second IFP of the invention and left for 24 hours at room temperature; FIG. 7b represents a preparation obtained by whipping aquafaba and left for 24 hours at room temperature; and

FIG. 8 represents a mayonnaise obtained from the second IFP of the invention (left) and from aquafaba (right).

### EXAMPLES

### Detailed Description of the Method for Obtaining a First Product

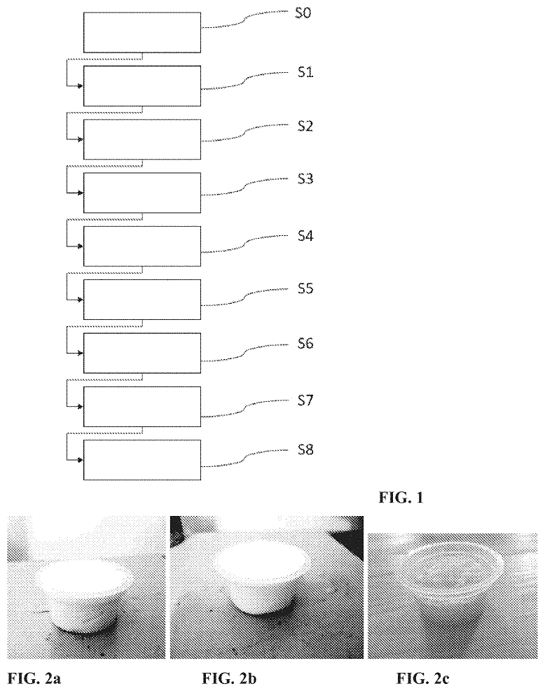

The present invention will now be described in what follows with reference jointly to FIG. 1 appended to the description.

For the record, one of the objectives of the present invention is to provide a culinary method for making an IFP having gelling and emulsifying properties and serving as a texturizing agent for making a final food product in the form of a gelatin, mousse or emulsion.

Another objective of the present invention is to use a vegetable component which, if possible, is grown locally in order to respect the environment by limiting pollution due to imports.

This is made possible within the context of the present invention by the use of field beans and the implementation of the various steps which will be described below.

As indicated above, the underlying concept is based especially on the use of field beans, field beans belonging to the legume family.

In the example described here and illustrated in FIG. 1, prior dehulling S0 of the field beans is provided.

Following this dehulling S0, the field beans are positioned in a tank (not represented here). Rehydration S2 of the field beans in the tank is then provided by soaking in water.

In the example described here, the tank is filled with water so that there are 2.5 volumes of water for 1 volume of field beans.

In order to have an optimal rehydration, soaking of the field beans in water is provided for a soaking time of approximately 16 hours.

The implementation of such soaking makes it possible to obtain a moisture content of the field beans substantially equal to 94% of moisture.

After soaking, the method provides for draining S3 of the field beans. Such draining S3 can for example be performed in the tank with a centrifuge. Alternatively, this draining can be performed with the use of a strainer system.

In the example described here, a so-called mixing step S4 is then provided, for mixing the field beans with water; this mixing is preferably carried out in a mixer (not represented here) and allows an aqueous mixture to be obtained.

In the example described here, 28.5% field beans and 71.5% water are introduced into the mixer. The person skilled in the art will understand that other substantially equivalent proportions can be implemented here without departing from the scope of protection of the present application. In the example described herein, a grinding step S5 for grinding the field beans is then provided in a grinder (not represented here); such grinding S5 makes it possible to release into the aqueous mixture the proteins and/or amylose contained in the field beans. The grinder allows particles ranging from 1 mm minimum to 3 mm maximum to be obtained.

In the example described here, a heating step S6 is provided during which the aqueous mixture is heated to a heating temperature of about 100° C. for a heating time of about 8 minutes.

At the end of this step S6, a preparation is obtained which consists of a viscous liquid and a cooked field bean grind dispersed in the viscous liquid. In this example, filtering S7 of the mixture to separate the field bean fibers and the field bean particles from the viscous liquid, and then heat treatment S8 to sterilize it are provided.

A first IFP is thus obtained, of vegetable origin only, which is ready for use and has the desired gelling and emulsifying properties.

The pH of this first IFP is 6.80.

Such an IFP will be particularly appreciated by its users for making a final food product in the form of:
a gelatin, for example of the savory or sweet flan type;
a mousse, for example of the meringue, macaroon or sponge cake type;
an emulsion, for example of the sauce or condiment type (mayonnaise, aioli, bearnaise, ganache, etc.).

### Example of a Method for Obtaining a Second and Third Product

The first product (first IFP) in the form of gel and/or more or less viscous liquid obtained according to the method described above is sterilized (50 mins at 120° C. at atmospheric pressure) and then left to rest (without stirring) for 5 days at a temperature less than or equal to 4° C. The product obtained separates into two phases, a liquid phase and a gel or solid phase. In mass, the solid phase (second IFP) represents 63% of the first IFP (before phase separation) and the liquid phase (3rd IFP) represents 37% of the first IFP. The same phase separation can be obtained by adding a weak or strong acid. Citric acid or an enzyme can be used to obtain the appearance of these two phases. If the first IFP has not been sterilized, it is possible to sterilize the two phases obtained. Preferably, the first IFP is sterilized.

In both cases, the sterilization is implemented at a temperature equal to or higher than 100° C. and equal to or lower than 150° C., preferably 120° C. for a time equal to or higher than 30 mins and equal to or higher than 60 mins, preferably equal to 50 mins, at atmospheric pressure. In FIG. 5a, it is noticed that two phases do appear when adding hydrochloric acid to the first IFP of the invention, whereas for the aquafaba, nothing happens after the addition of the same amount of hydrochloric acid (in the same amount of aquafaba as in the first IFP), apart from a slight lightening of the aquafaba. For this experiment, 30.0 g of aquafaba or the 1st IFP of the invention have been used. The amount of HCl acid added is the same in both cases, it is 1.0 g.

The liquid phase obtained when adding acid or when demixing after rest is the third IFP of the invention. It enables a mousse to be obtained by beating it with a whisk. It has the properties of egg white. It is visible in FIG. 6. The liquid fraction is an egg white substitute (meringues, mousses, financiers, etc.). Mousses made with this fraction are heat resistant.

The gel phase or solid phase (second IFP of the invention) has emulsifying and gelling properties. It allows the manufacture of a mayonnaise or a flan, for example. This second IFP is visible in FIG. 6. This 3rd IFP is:
a yolk substitute for making mayonnaise type sauces;
an ingredient in its own right for making flans and creams, whose interest lies in the pectin which acts as an appetite suppressant;
a cream substitute for making espumas (gas/liquid or gas/gel emulsion) and gas/gel) and a simulated Chantilly cream, a fat-free whipped cream. This 2nd IFP makes it possible to keep the stability of the mousse/emulsion obtained for 24 h, which does not occur when making mousses with the liquid fraction (3rd IFP). The 2nd IFP also enables egg yolk to be replaced in brioches or other pastries.

This second product liquefies when hot and becomes a gel again when cold. It also has gelling properties and allows jellies, flans, gummy candies, cold or hot dessert creams, etc. to be obtained.

Characterization of the Three Products and Comparison with the Cooking Juice of Whole Unground Chickpeas (Aquafaba)

1) Preparation of a Mousse with a Whisk

The same mass of aquafaba and the first IFP of the invention has been beaten separately and left to rest for 4 h at room temperature. At the instant T following their manufacture, both mousses have the same appearance (see FIG. 2b). After 4 hours, as visible in FIG. 2c, the aquafaba mousse is no longer a mousse but a sticky mass, whereas the mousse obtained with the first IFP of the invention is intact (see FIG. 2a).

The same results could be obtained with the third IFP of the invention.

2) Preparation of Meringues with the Third IFP of the Invention

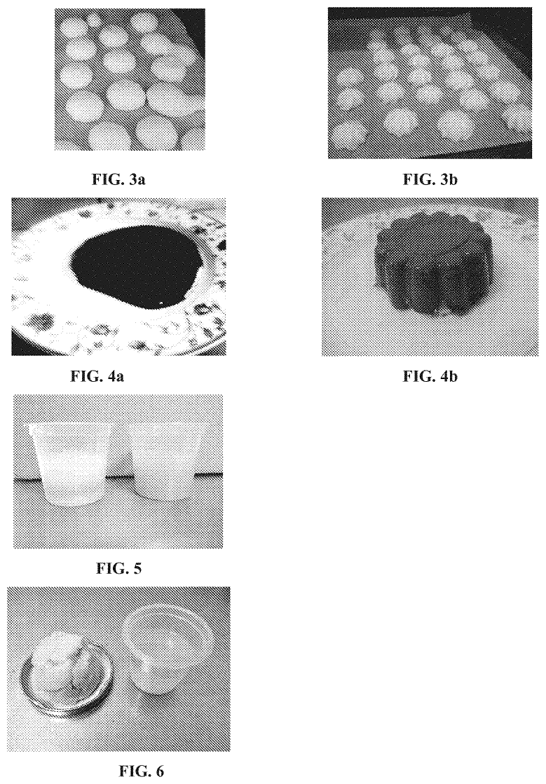

Meringues have been made with the same amounts of each ingredient. These meringues have been made by whipping, with a household electric whisk, respectively the first IFP or the third IFP of the invention and the aquafaba and adding fine white sugar at the end of obtaining the mousse (30% by mass of added white sugar). After cooking at the same temperature and for the same time (1 h), it is noticed that the meringues obtained from aquafaba are soft, sticky and have collapsed; they no longer have the shape that had been imparted to them during their manufacture with a piping bag (see FIG. 3a). On the contrary, the meringues obtained with the IFP of the invention are dry and crunchy; they have retained the shape imparted by the piping bag. It is thus noticed that the IFP of the invention makes it possible to obtain a stable and firm mousse after cooking, which is not the case with aquafaba.

3) Preparation of a Cocoa Flan with the Second IFP of the Invention

A cocoa flan has been made with 77% by mass of aquafaba, 20% sugar and 3% cocoa. The mixture has been mixed and then brought to a boil for 3 mins. It has then been poured into a mold and refrigerated for 6 h. The same recipe has been made with the second IFP of the invention. It can be noticed upon demolding that the aquafaba did not result in a formed flan (FIG. 4a clearly shows a puddle; the aquafaba preparation remained liquid). On the contrary, in FIG. 4b, it is clearly seen that the second IFP of the invention results in a flan that holds together upon demolding and for several hours thereafter.

It is possible to make a flan from cocoa, sugar, water and 2nd IFP of the invention by mixing the ingredients, then bringing them to a boil for 2 to 3 minutes. The mixture is then poured into a mold and cooled. A flan is obtained, that retains its shape for at least 24 hours even when cut. The 2nd IFP represents at least 60% by mass of the preparation before cooking.

4) Preparation of a Whipped Cream from the Second IFP of the Invention

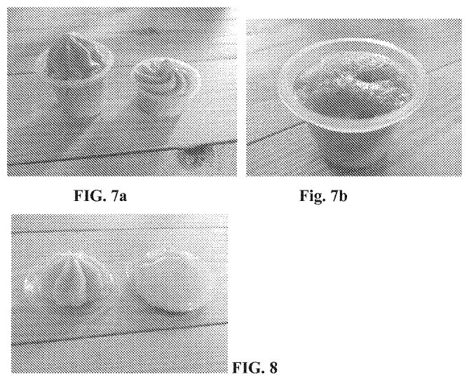

The second IFP of the invention has been whipped. A cream is obtained (see FIG. 7) whose texture is close to that of Chantilly cream and which is stable for at least 24 hours (it retains its shape and volume for at least 24 hours at room temperature). The same amount of aquafaba has been whipped for the same amount of time and at the same speed of rotation of the whisks. This whipped aquafaba preparation has been left at temperature for 24 h. The result is visible in FIG. 7b.

It is noticed in FIG. 7b that the espuma obtained with the aquafaba collapses after 4 hours at room temperature and forms a slippery mousse. On the contrary, as visible in FIG. 7a, the whipped preparation obtained with the third IFP of the invention has retained its shape and volume after 4 hours of rest at room temperature.

5) Preparation of a Mayonnaise with the Second IFP of the Invention

A mayonnaise has been made with the same mass proportions of oil and respectively aquafaba or the first or third IFP of the invention with a hand whisk. The oil used is rapeseed oil. In both cases, 80% by mass of oil and 20% IFP or aquafaba are used. It is noticed that after 24 hours of rest at room temperature, the mayonnaise obtained with the IFP of the invention has retained its shape and volume (see left mayonnaise in FIG. 8) whereas the mayonnaise obtained from aquafaba has collapsed and is being demixed (see right preparation in FIG. 8).

Tables 1 to 3 below summarize the different experiments.

TABLE 1

| | | | Mousse | | |
|---|---|---|---|---|---|
| | Specific | Expansion | specific | Mousse | Gelling |
| | gravity | coefficient | gravity | stability | power |
| 3^{rd} IFP | 1.00 | 428 | 0.18 | After 8 h | none |
| | | | | at 20° the | |
| | | | | mousse | |
| | | | | starts to | |
| | | | | decrease | |
| Aquafaba | 1.02 | 0.16 | | After 14 h | none |
| | | | | at 20° the | |
| | | | | mousse | |
| | | | | volume has | |
| | | | | decreased | |
| | | | | by ⅓ | |
| 2^{nd} IFP | 1.05 | 143 | 0.43 | Stable for | Strong. |
| | | | | 24 h | equivalent |
| | | | | minimum. | to an |
| | | | | The product | egg/milk |
| | | | | obtained is | mixture |
| | | | | between the | for creams |
| | | | | mousse and | and a |
| | | | | the | cream |
| | | | | emulsion, | substitute |
| | | | | more | for |
| | | | | compact, | espumas |
| | | | | very close | and |
| | | | | to the | whipped |
| | | | | texture of | cream. |
| | | | | a whipped | |
| | | | | cream. | |
| | | | | Allows | |
| | | | | espuma, | |
| | | | | topping and | |
| | | | | simulated | |
| | | | | Chantilly | |
| | | | | cream to be | |
| | | | | made | |
| | | | | without | |
| | | | | adding fat. | |

Moreover, it has been noticed that in the case of the 3rd IFP, the minimum mass proportion of sugar necessary for making meringue is 30% (3rd IFP+sugar=100%). The maximum proportion of sugar for obtaining meringues is 70%. In the case of aquafaba, at least 60% by mass of sugar is needed to obtain meringues. The maximum proportion of sugar is 80% in the case of aquafaba. It is therefore noticed that the 3rd IFP of the invention makes it possible to obtain less sugared meringues than with aquafaba.

TABLE 2

| | | Emulsion |
|---|---|---|
| | Emulsion (mayonnaise) | stability |
| 3rd IFP | Obtained after 6 mins, | Phase |
| (liquid) | addition of an acid | separation |
| | essential to help the | after 18 h |
| | setting of the mayonnaise. | to 20 h ° |
| | Proportions 80% of | |
| | sunflower oil for an | |
| | optimal emulsion. The | |
| | mayonnaise has been whisked | |
| | up by hand with a household | |
| | whisk. | |
| Aquafaba | Obtained after 7 mins, | The texture |
| | addition of an acid | was not |
| | essential to help the | very firm |
| | setting of the mayonnaise, | but did not |
| | but very average setting. | settle |
| | Proportions 80% of | after 24 h. |
| | sunflower oil for an | |
| | optimal emulsion. The | |
| | mayonnaise has been whisked | |
| | up with a hand whisk. | |
| 2nd IFP | Obtained after 1 min, very | Remains |
| | firm mayonnaise. | firm for |
| | Proportions of sunflower | several |
| | oil minimum 30%, maximum | days |
| | 40%. The mayonnaise has | |
| | been whisked up with a hand | |
| | whisk. | |

TABLE 3

| | Addition of hydrochloric | |
|---|---|---|
| | acid | Cooking |
| 3rd IFP | 1 g of acid for 30 g of | cooked |
| | product: T° 20°. | |
| | Precipitation of proteins. | |
| Aquafaba | 1 g of acid for 30 g of | cooked |
| | product: T° 20°: no phase | |
| | change or precipitate | |
| 2nd IFP | Product heated to 75° to | Liquefies |
| | liquefy. Addition of 1 g of | then gels |
| | acid for 30 g of product at | again |
| | 20° C.: no change of phase | |
| | observed, no precipitate | |
| | obtained | |

It is noticed that the 3rd IFP allows meringues, macaroons, dacquoise type pastries less sugared to be made than with egg white or egg white substitutes. The 3rd IFP has a totally neutral taste.

On the contrary, aquafaba requires the addition of large amounts of sugar for the hold and taste of the meringues. In addition, it is sometimes necessary to mask the bitter taste of chickpea noted when manufacturing mousses with flavors and/or sweeteners.

Finally, the 2nd IFP of the invention allows mayonnaise-type sauces (emulsions) to be made by reducing the amount of fat compared to the use of egg yolk or other egg substitute. This IFP contains at least amylopectin from the degradation of starch; it creates a quick and long-lasting feeling of satiety (appetite suppressant food). It allows vegetable cream desserts to be quickly made without going through a fermentation step. It has reversible gelling properties: once the product is gelled, it can be liquefied by heating. It gels again at room temperature.

1. A method for preparing an intermediate food product allowing a mousse and/or having emulsifying and/or gelling properties to be formed, the method comprising:
dehulling field beans,
rehydrating the dehulled field beans,
draining the rehydrated dehulled field beans,
mixing the drained field beans with water and grinding the mixture,
heating the mixture to a temperature of between 90° C. and 110° C. so as to obtain a liquid and/or a gel.

2. The method according to claim 1, wherein the rehydration of the field beans is carried out by soaking said field beans in water to achieve a moisture content of between 92% and 96% moisture, preferably 94%.

3. The method according to claim 2, wherein the soaking is carried out for a soaking time of between 12 hours and 20 hours, preferably substantially equal to 16 hours.

4. The method according to claim 3, wherein the soaking is carried out in two and a half volumes of water for one volume of field beans.

5. The method according to claim 3, wherein the mixture of water and ground field beans comprises 28.5% by mass of field beans and 71.5% of water.

6. The method according to claim 1, wherein the grinding is implemented so as to obtain particles having an average size equal to or greater than 1 mm and equal to or less than 3 mm.

7. The method according to claim 1, wherein said mixture is heated to a temperature equal to 100° C. and in particular heated to a temperature equal to 100° C. at atmospheric pressure.

8. The method according to claim 1, wherein the heating time is between 6 and 10 minutes, preferably substantially equal to 8 minutes.

9. The method according to claim 1, further comprising separating said liquid and/or gel from the heated mixture such that said liquid and/or gel is recovered.

10. The method according to claim 1, further comprising a heat treatment to sterilize said liquid and/or gel mixture obtained.

11. The method according to claim 1, further comprising separating the heated mixture into a solid phase and a liquid phase, either by demixing or by adding an acid.

12. An intermediate food product capable of forming a mousse and/or having emulsifying and/or gelling properties and capable of being obtained by the method according to claim 1, wherein it is in the form of a liquid and/or a gel, in that it comprises or consists of water, vegetable proteins, field bean starch and/or amylose and/or amylopectin, and in that it forms a solid precipitate when adding an acid.

13. An intermediate food product in gel or jelly form, obtainable according to the method according to claim 11 and having gelling and/or emulsifying properties, wherein it contains or consists of amylose, water and optionally vegetable proteins.

14. The intermediate food product according to claim 13, wherein it becomes liquid at a temperature greater than or equal to 60° C. and when it is hot-molded, upon cooling it forms a solid which retains its shape for at least three days at room temperature.

15. The intermediate food product according to claim 13, wherein it forms with an oil a stable emulsion for at least 24 hours at room temperature and/or in that it forms a stable mousse at 20° C. for at least 24 hours.

16. The intermediate food product according to claim 13, wherein it contains or consists of water, amylose and vegetable proteins.

17. A liquid food product obtainable according to the method of claim 11 and capable of forming a mousse and/or having emulsifying properties, wherein it contains or consists of water, vegetable proteins and amylopectin.

18. The liquid food product according to claim 17, wherein when whipped with a hand mixer, it forms a stable mousse for at least 8 hours at 20° C. and/or in that it forms a stable emulsion for 18 h at 20° C.

19. Use of the intermediate food product according to claim 12, for making a mousse.

20. Use of the food product intermediate according to claim 12, as an emulsifier.

21. A food product according to claim 1, wherein the food product is one selected from a group consisting of macaroon, meringue, cake batter, in particular sponge cake, cream, in particular selected from pastry cream, ganache cream and ice cream, a gelling agent, a sweet or savory flan, a sauce selected in particular from mayonnaise, bearnaise and aioli, and a condiment.

22. A texturizing agent, wherein it is in the form of a liquid or a gel and in that it comprises a product according to claim 1.

23. A food composition for manufacturing a food and being in the form of a gel and/or liquid, wherein it contains or consists of at least one of the food products according to claim 12 and at least one ingredient selected from a group consisting of sweeteners, especially sucrose, a cereal flour, cocoa and an oil.
